(19) United States
(12) Patent Application Publication
(10) Pub. No.: US 2010/0070699 A1
(43) Pub. Date: Mar. 18, 2010

(54) HYBRID HARD DISK DRIVE CAPABLE OF STORING FILE HAVING SPECIFIED CONDITION, A METHOD OF CONTROLLING THE SAME, AND RECORDING MEDIUM ADAPTED FOR EXECUTING THE METHOD

(75) Inventors: Sang-hoon LEE, Suwon-si (KR); Se-wook NA, Suwon-si (KR); In-sik RYU, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/557,571

(22) Filed: Sep. 11, 2009

(30) Foreign Application Priority Data
Sep. 11, 2008 (KR) 2008-90001

(51) Int. Cl. G06F 12/00

(52) U.S. Cl. 711/112; 711/E12.001; 707/E17.01

(57) ABSTRACT

A method of controlling a hybrid hard disk drive includes receiving a write command from a host; extracting metadata of a file to be written, determining whether the metadata satisfies a predetermined set condition, and storing the file to be written in a first storage device when the metadata satisfies the set condition.

### CROSS-REFERENCE TO RELATED APPLICATIONS

This application claims the benefit of priority under 35 U.S.C. §119 from Korean Patent Application No. 10-2008-0090001, filed on Sep. 11, 2008, in the Korean Intellectual Property Office, the disclosure of which is incorporated herein in its entirety by reference.

### BACKGROUND

1. Field of the Invention

The inventive concept relates to a hard disk drive, and more particularly, to a hybrid hard disk drive including a hard disk, which is a primary storage device, and a non-volatile memory, which is a secondary storage device, as storing medium for storing data.

2. Description of the Related Art

A hard disk drive is a data storage device for reading data a disk or writing data to the disk using a magnetic head. In current high-capacity, high density, and light weighted hard disk drives, Bit Per Inch (BPI) and Track Per Inch (TPI), which are respectively denoted as data intensity in a disk in a rotating direction and in a radius direction, are increasing. Accordingly, hard disk drive performance may be improved by reducing a flying height of the magnetic head and increasing the writing frequency.

Meanwhile, a hybrid hard disk drive has been developed that includes a hard disk as a primary storage device and a non-volatile memory as a secondary storage device.

In the general hybrid hard disk drive, a method of selecting whether a specific data file is stored in a hard disk or a non-volatile memory is not provided. Consequently, a user may not be able to store a file having a particular characteristic in a particular storage device. For example, a use may not be able to direct files having a specific file name, most-often-used files, or a file having a specific extension to a particular storage device to allow for quick execution of data. Thus, performance of the hybrid hard disk drive may not be optimized.

### SUMMARY

The inventive concept provides a hybrid hard disk drive improving data execution speed by reading the data from a non-volatile memory when a data file having a specific information set by a user is stored in the non-volatile memory having high data access speed and reading the data file is requested from a host, a method of controlling the hybrid hard disk drive, and a writing medium adapted for executing the method.

Additional features and utilities of the present general inventive concept will be set forth in part in the description which follows and, in part, will be obvious from the description, or may be learned by practice of the general inventive concept.

According to a feature of the present inventive concept, there is provided a method of controlling a hybrid hard disk drive, the method including receiving a write command from a host; extracting metadata of a file to be written, determining whether the metadata satisfies a predetermined set condition, and storing the file to be written in a first storage device when the metadata satisfies the set condition. The file to be written may be stored in a second storage device when the metadata does not satisfy the set condition.

The set condition may include at least one of a file folder type, a file extension, a file capacity, and file name. The set condition may be added, changed, and deleted by a user. The first storage device may be a non-volatile memory device, and the second storage device may be a hard disk.

Additional features and utilities of the present inventive concept may be realized by a method of controlling a hybrid hard disk drive, the method including determining whether information of a file to be written satisfies a predetermined set condition, and storing the file to be written in a first storage device and storing a logic block address of the file to be written in a logic block address list when the information of the file to be written satisfies the set condition. The file may be written to a second storage device when the information of the file does not satisfy the set condition.

A method for controlling a hybrid disk drive may further include receiving a read command from a host, extracting the logic block address of a file to be read, determining whether the logic block address is included in the logic block address list, and reading the file to be read from the first storage device when the logic block address is included in the logic block address list. The file may be read from the second storage device when the logic block address is not included in the logic block address list.

The metadata may include at least one of file paths, file extensions, file capacities, and file names.

The method may include determining whether the logic block address of a file to be read is included in the logic block address list; and reading the file to be read from the first storage device and sending the read file to a host when the logic block address is included in the logic block address list.

Additional features and utilities of the inventive concept may be realized by a hybrid hard disk drive including a first storage device used as a main storage device, a second storage device used as a sub-storage device, and a central processing unit (CPU). The CPU may receive a write command from a host, determine whether metadata of a file to be written satisfies a predetermined set condition, and when the metadata satisfies the set condition, the CPU may store the file to be written in a second storage device and add the logic block address of the file to be written to a logic block address list.

The logic block address list may be stored in either the first storage device.

The CPU may store the file to be written in the first storage device when the metadata does not satisfy the set condition. The CPU may receive a read command from a host, determine whether the logic block address of a file to be read is included in the logic block address list, and, when the logic block address is included in the logic block address list, the CPU may read the file to be read from the second storage device and sends the read file to the host. The CPU may read the file to be read from the first storage device when the logic block address is not included in the logic block address list.

The first storage device may include at least one disk and the second storage device may comprise at least one of PRAM, FRAM, MRAM, RRAM, NRAM, NAND Flash, and a NOR flash device.

Other features and utilities of the present inventive concept may be achieved by a computer readable recording medium having embodied thereon a computer program to execute a method, the method including determining whether file information satisfies a predetermined condition, storing the file in a first storage device when the file information satisfies the predetermined condition, and storing the file in a second storage device when the file information does not satisfy the predetermined condition. The file information may include file metadata.

Other features and/or utilities of the present general inventive concept may be realized by a method for controlling a hybrid disk drive, the method including setting at least one condition to be determined in a write process of the hybrid disk drive, and directing the hybrid disk drive to write a file to a first storage device if the condition is met, and directing the hybrid disk drive to write a file to a second storage device if the condition is not met.

The condition may be one of a file folder type, a file extension, a file capacity, a file size, and file name.

Other features and/or utilities of the present general inventive concept may be realized by a hybrid hard disk including a first storage device having a first format and a first capacity, a second storage device having a second format and a second capacity different from the first storage device, a controller to receive a write command and to store a file corresponding to a write command in one of the first storage device and the second storage device according to a determination of whether the metadata corresponds to a reference.

The first storage device has a larger capacity and a slower data retrieval rate than the second storage device. For example, the first storage device may be a hard disk device and the second storage device may be a non-volatile memory device.

The controller may store the file to the non-volatile memory device when the metadata corresponds to the reference, and the controller may store the file to the hard disk device when the metadata does not correspond to the reference.

The hybrid hard disk may include a logic block address list, and the controller may save a logic block address of the file to a logic block address list when the controller saves the file to the second storage device.

The logic block address list may be located in the second storage device.

The controller may read the logic block address list upon receiving a read command. When the logic block address of the file is located in the logic block address list, the controller may read a file corresponding to the read command from the second storage device. When the logic block address of the file is not located in the logic block address list, the controller may read the file from the first storage device.

Additional features and utilities of the present inventive concept may be realized by a method for controlling a hybrid disk drive, the method including setting at least one condition to be determined in a write process of the hybrid disk drive, directing the hybrid disk drive to write a file to a first storage device if the condition is met, and directing the hybrid disk drive to write a file to a second storage device if the condition is not met.

### BRIEF DESCRIPTION OF THE DRAWINGS

Exemplary embodiments of the inventive concept will be more clearly understood from the following detailed description taken in conjunction with the accompanying drawings in which:

FIG. 1 illustrates a hybrid hard disk drive according to an embodiment of the general inventive concept;

FIG. 2A illustrates a computer system including a hard disk drive according to an embodiment of the general inventive concept;

FIG. 2B illustrates a computer system including a host and a hard disk drive according to an embodiment of the present general inventive concept;

FIG. 3 is a block diagram of a hybrid hard disk drive according to another embodiment of the general inventive concept;

FIG. 4 is a flowchart illustrating a method of controlling a hybrid hard disk drive according to an embodiment of the general inventive concept;

FIG. 5 is a flowchart illustrating a method of controlling a hybrid hard disk drive according to another embodiment of the general inventive concept; and

FIG. 6 is a flowchart illustrating a method of controlling a hybrid hard disk drive.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

In the description, the detailed descriptions of well-known technologies and structures may be omitted so as not to hinder the understanding of the embodiments.

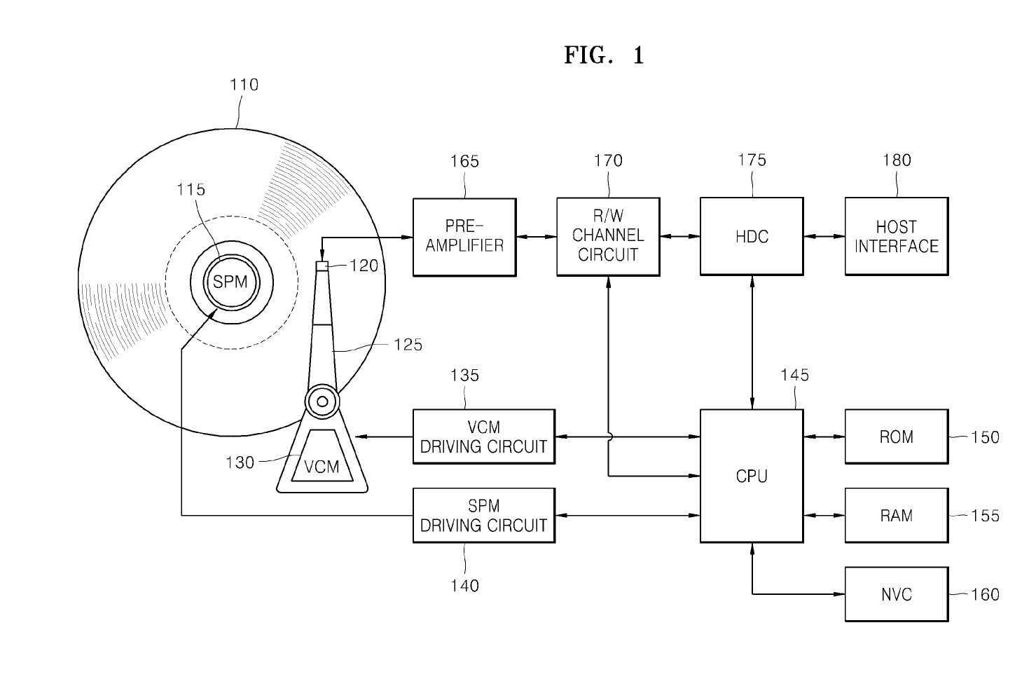

FIG. 1 illustrates a hybrid hard disk drive (HDD) according to an embodiment.

Referring to FIG. 1, the hybrid HDD according to the current embodiment includes a disk 110, a spindle motor (SPM) 115, a head 120, an actuator 125, a voice coil motor (VCM) 130, a VCM driving circuit 135, a SPM driving circuit 140, a central processing unit (CPU) 145, a read only memory (ROM) 150, a random access memory (RAM) 155, a non-volatile cache (NVC) 160, a pre-amplifier 165, a read/write (R/W) channel circuit 170, a hard disk controller (HDC) 175, and a host interface 180. Hereinafter, these elements are described in more detail.

The disk 110 has two disk surfaces and one of them is used as a writing surface to which data is written. The disk 110 may in fact include multiple disks. In general, information is written to concentric circular tracks of the disk 110. The head 120 is used to write data to the disk 110 and read data from the disk 110. The head 120 includes a write head and a read head. In addition, there may be multiple read and write heads. The actuator 125 includes the head 120 and moves the head 120 over the disk 110.

The speed of the SPM 115 is controlled by the SPM driving circuit 140 and rotates the disk 110 at fixed speed. The speed of the VCM 130 is controlled by the VCM driving circuit 135 and moves the actuator 125 within a fixed range. The pre-amplifier 165 amplifies a reading signal read by the head 120 and converts writing data into a writing current. The R/W channel circuit 170 performs analog-to-digital (A/D) conversion to the amplified reading signal, encodes the writing data, and decodes the reading data.

The HDC 175 sends a command input from a host (not illustrated) to the CPU 145 and sends data input from the R/W channel circuit 170 to the host. The ROM 150 stores control programs and various parameters. The RAM 155 provides a task performing space of the CPU 145. The non-volatile cache 160 is a non-volatile memory which may write data. Here, the non-volatile cache 160 may be a NAND flash or a NOR flash. The CPU 145 controls a whole process and may be a microprocessor or a digital signal processor.

When the CPU 145 receives a write command from the host, the CPU 145 determines whether metadata of a file to be written, which is the object of the write command, satisfies a predetermined condition. The condition may be directly set by a user and may be stored in a condition list. The condition list may be stored in some part of the non-volatile cache 160, for example. When the meta data of the file to be written does not satisfy the condition, the CPU 145 stores the file to be written, which is the object of the write command, in the disk 110.

The hard disk controller 175 and the CPU 145 may be a single control unit to include functions of a hard disk controller 175 and a CPU 145, including controlling ROM 150, RAM 155, non-volatile cache memory 160, and the hard disk control units 115 (spindle motor), 120 (magnetic head), 125 (actuator), 130 (voice coil motor), 135 (VCM driving circuit), and 140 (spindle motor driving circuit).

When the meta data of the file to be written satisfies the condition, the CPU 145 stores the file to be written, which is the object of the write command, in the non-volatile cache 160 and adds logic block addresses of the file to be written stored in the non-volatile cache 160 to a predetermined logic block address list. The logic block address list represents the logic block address of the file stored in the non-volatile cache 160. The logic block address list may be stored in some part of the non-volatile cache 160, for example. The condition may be an extension (*.mpg, *.avi), a capacity (100 Mb or more), a folder name (download folder), or any other characteristic of the file and may be changed by a user.

When the CPU 145 receives a read command from the host, the CPU 145 determines whether logic block address of a file to be read, which is the object of the read command, is included in the logic block address list. When the logic block address of the file to be read is not included in the logic block address list, the CPU 145 reads the file to be read from the disk 110 and sends the read file to the host. When the logic block address of the file to be read is included in the logic block address list, the CPU 145 reads the file to be read from the non-volatile cache 160 and the sends the read file to the host.

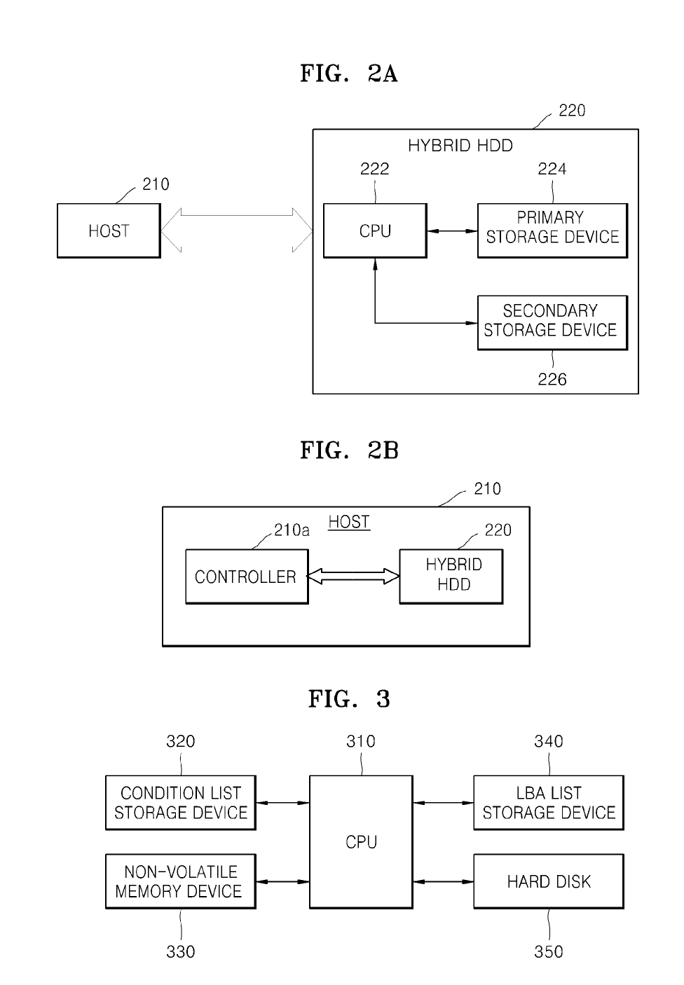

FIG. 2A illustrates a computer system including a hard disk drive (HDD) according to an embodiment.

Referring to FIG. 2A, the computer system according to the current embodiment includes a host 210 and a hybrid HDD 220. The hybrid HDD 220 includes a CPU 222, a primary storage device 224, and a secondary storage device 226. Hereinafter, these elements are described in more detail.

The host 210 may be a personal computer or a microprocessor installed to the personal computer. The host 210 sends a write/read command to the hybrid HDD 220 and receives read data from the hybrid HDD 220. In response to the write/read command received from the host 210, the CPU 222 writes data into the primary storage device 224 or the secondary storage device 226 or reads data from the primary storage device 224 or the secondary storage device 226. The primary storage device 224 may be a disk and the secondary storage device 226 may be a non-volatile memory, for example.

The CPU 222 searches the metadata of the file to be written, which is the object of the write command, received from the host 210. When the meta data satisfies a predetermined condition, the CPU 222 stores the file to be written in the secondary storage device 226 and then adds the logic block address of the file to be written stored in the secondary storage device 226 to the logic block address list. Then, when the CPU 222 receives the read command including the logic block address of the file to be written from the host 210, the CPU 222 reads the file to be read from the secondary storage device 226 and sends the read file to the host 210.

FIG. 2B illustrates an embodiment of the present general inventive concept in which the host 210 includes a controller 210a and the hybrid HDD 220. It is possible that the hybrid HDD 220 may be connectable to the host 210, as shown in FIG. 2A, via a communication line and terminals. However, it is also the hybrid HDD 220 may also be installed inside the host 210. The hybrid HDD may be controlled by a controller 210a within the host 210.

FIG. 3 is a block diagram of a hybrid hard disk drive (HDD) according to an embodiment of the present inventive concept.

Referring to FIG. 3, the hybrid HDD includes a CPU 310, a condition list storage device 320, a non-volatile memory 330, a logic block address list storage device 340, and a hard disk 350. Hereinafter, these elements are described in more detail.

The CPU 310 is operated according to a write/read command sent from a host (not illustrated). The CPU 310 may be a digital signal processor, a microprocessor, or a microcontroller. The CPU 310 may write a file that is the object of the write command to either the non-volatile memory 330 or the hard disk 350. The CPU may read the file that is the object of the read command from either the non-volatile memory 330 or the hard disk 350. For example, when the file satisfies a predetermined condition, the CPU 310 stores the file in the non-volatile memory 330 or reads the file from the non-volatile memory 330.

The condition list storage device 320 is a device to store a predetermined condition set by a user and may either be part of the non-volatile memory 330 or a separate storage device. The logic block address list storage device 340 is a device to store the logic block address of the data file stored in the non-volatile memory 330 and may either be part of the non-volatile memory 330 or a separate storage device. The non-volatile memory 330 may include RAM, FRAM, MRAM, RRAM, NRAM, NAND flash, or NOR flash, for example.

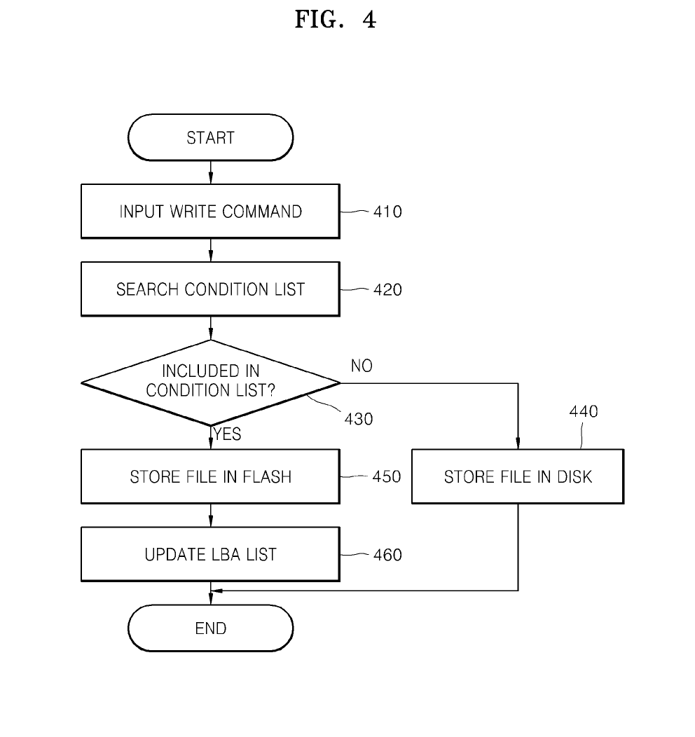

FIG. 4 is a flowchart illustrating a method of controlling a hybrid hard disk drive according to an embodiment of the present inventive concept.

Referring to FIG. 4, a write command is received from a host in operation 410. The write command may include metadata of a file to be written. A condition list storing a condition set by a user is searched in operation 420. The condition list may be stored in a flash memory, for example. In operation 430, it is determined whether the metadata of the file to be written satisfies the set condition included in the condition list. When the metadata does not satisfy the set condition, the file to be written may be stored in a hard disk in operation 440.

When the metadata satisfies the set condition, the file to be written may be stored in a flash memory in operation 450. Then, a logic block address of the file to be written stored in the flash memory is added to a predetermined logic block address list in operation 460. The logic block address list represents the logic block addresses of all files stored in the flash memory. Accordingly, a user may selectively store data files having different characteristics in different devices by setting the tested conditions to correspond to the different characteristic.

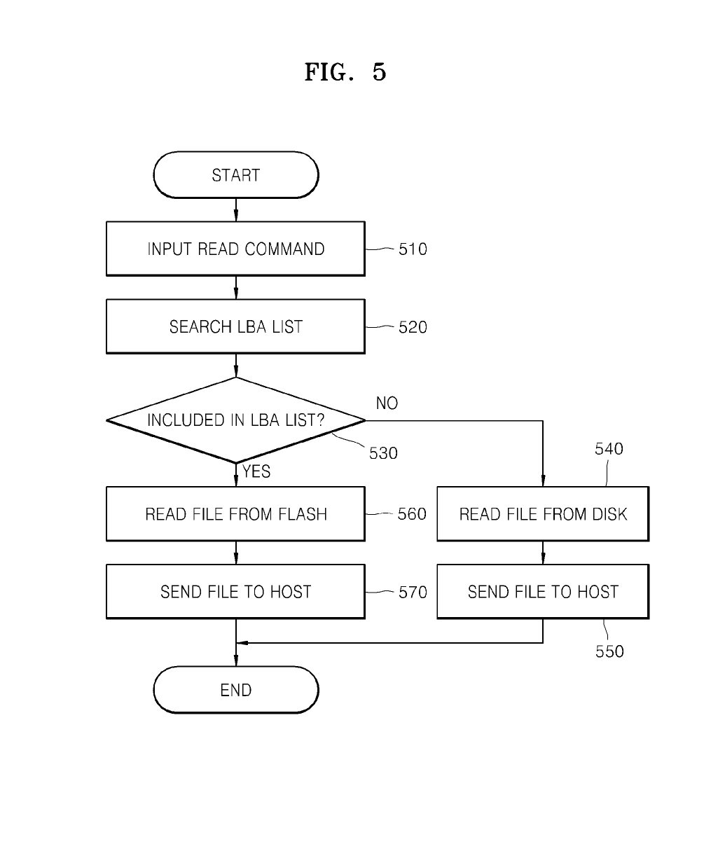

FIG. 5 is a flowchart illustrating a method of controlling a hybrid hard disk drive according to another embodiment of the present inventive concept.

Referring to FIG. 5, a read command is received from a host in operation 510. The read command includes a logic block address of a file to be read. A logic block address list is searched in operation 520 to determine if the logic block address of the file to be read is located on the list (operation 530). The logic block address list may be data stored in a flash memory, for example. If the logic block address is not included in the logic block address list, the file is read from the hard disk in operation 540. The read file is sent to the host in operation 550.

If the logic block address is included in the logic block address list, the file is read from the flash memory using the logic block address in operation 560. The read file is sent to the host in operation 570. The logic block address list may be an index indicating whether the file to be read is stored in the hard disk or the flash memory. Accordingly, the user may confirm where a specific data file is stored.

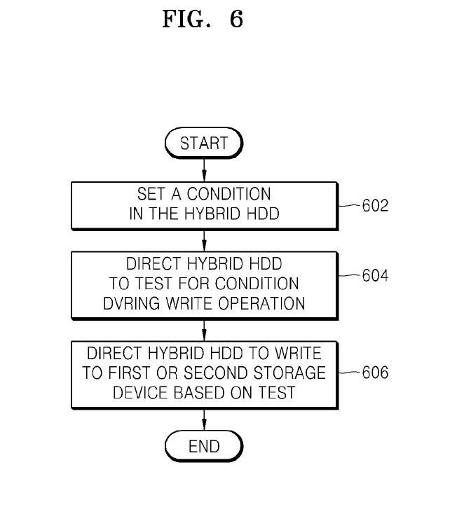

Referring to FIG. 6, a device containing a hybrid hard disk may be programmed to search for a condition (operation 602). The device may be programmed by a user, by a manufacturer, by a vendor, or may be automatically set. When the condition is set, the device may be programmed to conduct a test for the condition during write operations (operation 604). For example, the device may be programmed to conduct the test shown in FIG. 4 to detect the presence of the condition. The device may then be programmed to write to a first storage device if the condition is met and to a second storage device if the condition is not met (operation 606).

Similarly, the device may be programmed to detect a logic block address of a file to be read and to read the file from either the first storage device or the second storage device depending on whether the logic block address of the file is located on a logic block address list.

For example, in a device containing a hard disk and non-volatile memory, a user may program the device to write every file with a .mp3 suffix, or every file that has been used more than once in the last 24 hours, to the non-volatile memory. When the device receives a write command, it would check the file-to-be-written to determine if it had an .mp3 suffix or had been used more than once in the last 24 hours. If so, the file would be saved to the non-volatile memory and the logic block address of the file could be saved to a logic block address list. Otherwise, the file would be written to the hard disk.

When the device receives a command to read a file, it may read the logic block address of the file-to-be-read and compare it to the addresses on the logic block address list. If the logic block address of the file-to-be-read is located on the logic block address list, then the device may read the file from the non-volatile memory. Otherwise, the device may read the file from the hard disk.

As described above, according to the one or more of the above embodiments, the features and utilities of the present inventive concept may be realized as a method, a device, and a system. When portions of the embodiments are executed as software, the elements described in the embodiments are code segments executing the needed task. Program codes or code segments may be stored in a processor readable medium and may be transmitted by a computer data signal combined with a carrier wave in a transmission medium or a communication network.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

While the present general inventive concept has been particularly shown and described with reference to exemplary embodiments thereof, it will be understood that various changes in form and details may be made therein without departing from the spirit and scope of the following claims.

What is claimed is:

1. A method of controlling a hybrid hard disk drive, the method comprising:
receiving a write command from a host;
extracting metadata of a file to be written corresponding to the write command;
determining whether the metadata satisfies a predetermined set condition; and
storing the file to be written in a first storage device when the metadata satisfies the set condition.

2. The method of claim 1, further comprising:
storing a logic block address of the file to be written in a logic block address list when the metadata satisfies the set condition.

3. The method of claim 2, further comprising:
receiving a read command from a host;
extracting the logic block address of a file to be read;
determining whether the logic block address is included in the logic block address list; and
reading the file to be read from the first storage device when the logic block address is included in the logic block address list.

4. The method of claim 1, wherein the metadata comprises at least one of file paths, file extensions, file capacities, and file names.

5. The method of claim 1, wherein the set condition comprises at least one of a file folder type, a file extension, a file capacity, and file name.

6. The method of claim 1, wherein the set condition is able to be added, changed, and deleted by a user.

7. The method of claim 2, wherein the list is located in some part of the first storage device.

8. The method of claim 1, wherein the first storage device is a non-volatile memory device.

9. A method of controlling a hybrid hard disk drive, the method comprising:
determining whether information of a file to be written satisfies a predetermined set condition; and
storing the file to be written in a first storage device and storing a logic block address of the file to be written in a predetermined logic block address list when the information of the file to be written satisfies the set condition.

10. The method of claim 9, further comprising:
determining whether the logic block address of a file to be read is included in the logic block address list; and
reading the file to be read from the first storage device and sending the read file to a host when the logic block address is included in the logic block address list.

11. A computer readable recording medium having embodied thereon a computer program to execute a method, the method comprising:
determining whether file information satisfies a predetermined condition; and
storing the file in a first storage device when the file information satisfies the predetermined condition.

12. A hybrid hard disk drive comprising:
a first storage device used as a main storage device;
a second storage device used as a sub-storage device; and
a central processing unit (CPU) to receive a write command from a host, to determine whether metadata of a file to be written satisfies a predetermined set condition, and, when the metadata satisfies the set condition, to store the file to be written in the second storage device and to add the logic block address of the file to be written in a logic block address list.

13. The hybrid hard disk drive of claim 16, wherein the CPU stores the file to be written in the first storage device when the metadata does not satisfy the set condition.

14. The hybrid hard disk drive of claim 16, wherein the CPU receives a read command from a host, determines whether the logic block address of a file to be read is included in the logic block address list, and, when the logic block address is included in the logic block address list, reads the file to be read from the second storage device and sends the read file to the host.

15. The hybrid hard disk drive of claim 18, wherein the CPU reads the file to be read from the first storage device when the logic block address is not included in the logic block address list.

16. The hybrid hard disk drive of claim 16, wherein the first storage device comprises at least one disk and the second storage device comprises at least one of PRAM, FRAM, MRAM, RRAM, NRAM, NAND Flash, and a NOR flash device.

17. A method for controlling a hybrid disk drive, the method comprising:
setting at least one condition to be determined in a write process of the hybrid disk drive; and
directing the hybrid disk drive to write a file to a first storage device if the condition is met, and directing the hybrid disk drive to write a file to a second storage device if the condition is not met.

18. The method according to claim 17, wherein the first storage device is a non-volatile memory device and the second storage device is a hard disk device.

19. The method according to claim 17, wherein the condition is one of a file folder type, a file extension, a file capacity, a file size, and file name.

20. A hybrid hard disk drive comprising:
a first storage device having a first format and a first capacity;
a second storage device having a second format and a second capacity different from the first storage device; and
a controller to receive a write command and to store a file corresponding to a write command in one of the first storage device and the second storage device according to a determination of whether the metadata corresponds to a reference.

21. The hybrid hard disk drive of claim 20, wherein the first storage device has a larger capacity and a slower data retrieval rate than the second storage device.

22. The hybrid hard disk drive of claim 20, wherein the first storage device is a hard disk device and the second storage device is a non-volatile memory device.

23. The hybrid hard disk drive of claim 22, wherein the controller stores the file to the non-volatile memory device when the metadata corresponds to the reference, and the controller stores the file to the hard disk device when the metadata does not correspond to the reference.

24. The hybrid hard disk drive of claim 20, further comprising a logic block address list,
wherein the controller saves a logic block address of the file to a logic block address list when the controller saves the file to the second storage device.

25. The hybrid hard disk drive of claim 24, wherein the logic block address list is located in the second storage device.

26. The hybrid hard disk drive of claim 24, wherein the controller reads the logic block address list upon receiving a read command and reads a file corresponding to the read command from the second storage device when the logic block address of the file is located in the logic block address list, and reads the file from the first storage device when the logic block address of the file is not located in the logic block address list.
